(19) United States
(12) Patent Application Publication
(10) Pub. No.: US 2018/0317597 A1
(43) Pub. Date: Nov. 8, 2018

(54) SYSTEMS, APPARATUSES, AND METHODS FOR HEATED ARTICLE

(71) Applicant: LOOMIA Technologies, Inc., New York, NY (US)

(72) Inventors: Madison Thea MAXEY, New York, NY (US); Ezgi Uçar, Istanbul (TR); Janett Martinez, Queens, NY (US)

(21) Appl. No.: 15/972,665

(22) Filed: May 7, 2018

Related U.S. Application Data
(60) Provisional application No. 62/503,044, filed on May 8, 2017.

(51) Int. Cl. A43B 7/04; A43B 3/00; A43B 19/00; A43B 1/14; H05B 1/02; H05B 3/34

(52) U.S. Cl. CPC A43B 7/04; A43B 3/0005; A43B 19/00; A43B 7/12; H05B 1/0252; H05B 3/34; A43B 1/14

(57) ABSTRACT

A heated article comprises a circuit board; one or more batteries electrically connected to the circuit board; a flexible heating element electrically connected to the circuit board; a control switch electrically connected to the circuit board and configured to selectively adjust the heating element; and circuitry configured to charge the one or more batteries.

### CROSS-REFERENCE TO RELATED APPLICATION

This patent application claims the benefit under 35 U.S.C. § 119 to U.S. Provisional Patent Application No. 62/503,044, filed on May 8, 2017, the entirety of which is incorporated herein by reference.

### TECHNICAL FIELD

The present disclosure relates generally to the field of heating elements for articles such as textile articles, including apparel and footwear.

### BACKGROUND

Various products are sold as sources of warmth for the extremities, for example, boots, shoes, or other suitable footwear having an insole. In cold environmental conditions, the extremities, such as toes, are particularly susceptible to losing body temperature and becoming uncomfortably cold. To provide insulation from these cold temperatures, shoe uppers typically are made of leather or cloth, shoe soles are made of leather or rubber materials, and shoe insoles and liners include padding and other materials. The insulating properties of these materials help to retain heat from blood circulation through the foot. Heating elements disposed within footwear, e.g., a heel or insole of a shoe, have been introduced to address these problems.

In some products, a heating element is inserted within a sole, a heel, or other suitable portion of footwear. Some products rely on a battery current flowing through a resistive heating element to produce heat in the vicinity of the resistive element. In many instances, a battery is located outside the article of clothing, or footwear, via an electrical connection, e.g., a flat wire, so as to provide battery power to the resistive heating element. However, these electrical heating elements are somewhat vulnerable to failure because they are created using traditional electronics techniques that are not flexible and adaptable for textiles. Further, such electrical heating elements commonly are powered by lithium ion batteries which are prone to explosion. Further, these heating elements are often bulky and made of cylindrical wires that are not comfortable, flat and drapable for the user.

Moreover, in many of the heating elements of previous systems, these heating elements have been difficult to implement with a unique footwear design due to their bulky size and/or shape. These heating elements are limited in their flexibility as a consequence of design and/or manufacturing deficiencies. Owing to these deficiencies, these heating elements may be difficult to incorporate into varying types of footwear, e.g., heels of footwear having various styles, shapes, and/or sizes.

### SUMMARY

According to certain aspects of the present disclosure, systems, apparatuses, and methods for heated footwear are disclosed.

In one embodiment, a heated article comprises a circuit board; one or more batteries electrically connected to the circuit board; a flexible heating element electrically connected to the circuit board; a control switch electrically connected to the circuit board and configured to selectively adjust the heating element; and circuitry configured to charge the one or more batteries.

In accordance with another embodiment, a heated article comprises a flexible heating element; a rechargeable battery, wherein the rechargeable battery is configured to provide power to the flexible heating element; circuitry for connecting the rechargeable battery to the flexible heating element; and a temperature sensor connected to the circuitry.

In accordance with another embodiment, a flexible heating element comprises a textile; a rechargeable battery, wherein the rechargeable battery is configured to provide power to the flexible heating element; circuitry for connecting the rechargeable battery to the flexible heating element; and an LED indicator.

Additional objects and advantages of the disclosed embodiments will be set forth in part in the description that follows, and in part will be apparent from the description, or may be learned by practice of the disclosed embodiments. The objects and advantages on the disclosed embodiments will be realized and attained by means of the elements and combinations particularly pointed out in the appended claims.

It is to be understood that both the foregoing general description and the following detailed description are exemplary and explanatory only and are not restrictive of the detailed embodiments, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 is a schematic diagram depicting a cross-sectional view of aspects of an exemplary system for heated footwear.

FIG. 2 depicts aspects of an exemplary apparatus for heated footwear.

FIG. 3 depicts aspects of exemplary heating elements.

### DETAILED DESCRIPTION

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the methods described herein for producing flexible, drapable electronic circuitry layers. The technology disclosed herein, in one example, is a textile-based heating element (e.g., a pad) integrated into either footwear or apparel (e.g., a heel or insole of a shoe) for use in heating the wearer's foot. In an exemplary embodiment, disclosed is a system, apparatus, and method of integrating an electronic heating system into a shoe or other suitable footwear and/or apparel. In the exemplary embodiment, the heating element may be textile-based and encapsulated using a polymer material so that the heating element may be disposed comfortably within a thin insole of a shoe or other suitable footwear. The heating element may be flat and flexible with a low bend radius.

The system described herein may be designed so that it is modular for various types of footwear, including footwear with a heel, e.g., any heeled styled shoe, or footwear with an insole, e.g., any shoe or sneaker with a large, flat sole. Moreover, the system disclosed herein may be manufactured to provide a flat, flexible, textile-based heating element to fit within a shoe. In an exemplary embodiment, the design of the shoe or boot may be modular and include power in the heel of the shoe, and the heel may connect to the upper of the shoe using plugs or other suitable electrical connections. This modular design allows for easy manufacturing between an electronics facility and a shoe producer.

The technology disclosed herein may have several industrial applications. For example, the system may be used by construction workers, cold-weather athletes, elderly persons, handicapped persons, or any other suitable person. In the exemplary embodiment, the system may include functionality for controlling the temperature of the textile-based heating element with a temperature sensor (e.g., a thermistor or any other suitable sensor). The system may be powered using a battery or batteries, e.g., a rechargeable battery. In some examples, the rechargeable battery may be a Nickel-metal hydride battery (NiMH). The battery may be integrated into a heel of a shoe, or similar footwear, and may be charged using an induction charging circuit or a contact charge connector. The entire heel may be waterproof for safety or the electronics may be insulated within a non-waterproofed shoe

### Exemplary Features of Disclosed Technology

The technology disclosed herein may include embodiments with one or more of the following: a battery pack heel; an induction charging or contact charging heel; a heel-to-insole electrical snap connection design; a focused area heating panel pattern(s); a waterproof heel; a flat, slim connector(s) for the heating panel wiring; and a cut, flat and lightweight textile heating element using temperature sensitive conductive adhesives.

In an exemplary embodiment, a heated shoe with a heating element is described below. The exemplary embodiment may include a textile-based heating element with a bonded fabric, e.g., a heating element bonded to or disposed within a fabric, a textile, or other suitable material. The exemplary embodiment described below also discloses a streamlined connection method. For example, to establish easy connectivity between the heel of a shoe, containing a power source, e.g., NiMH batteries, and the printed circuit board corresponding to the heating element, e.g., heating panel. This streamlined connectivity may be useful in electrically connecting the batteries disposed within the heel of the disclosed system with the corresponding electrical connections of the PCB of the heating element. The exemplary embodiment may also include a power source, e.g., a battery, or other suitable power source, which may be disposed within a portion of the footwear, e.g., a heel of a shoe. Furthermore, the exemplary embodiment may include a thermal regulation feature or mechanism for controlling the temperature of the aforementioned heating element.

### Exemplary Heated Shoe System

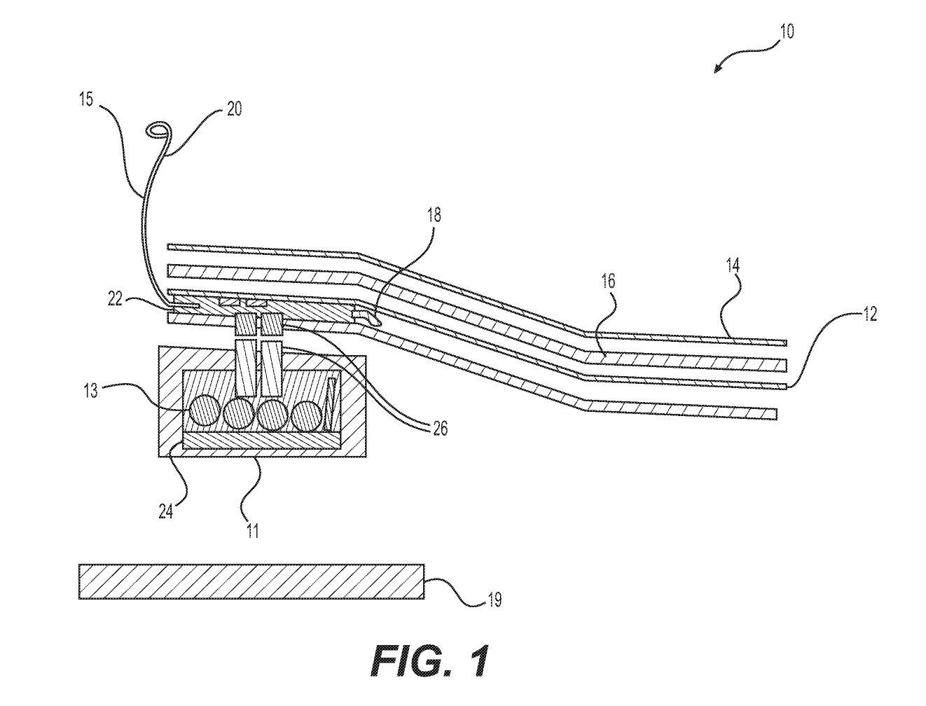

With reference now to FIGS. 1-3, an exemplary heated shoe system will be described.

FIG. 1 illustrates an exemplary embodiment of a heated shoe 10. Heated shoe 10 may be comprised of an upper section 15 and a heel 11. Upper section 15 of heated shoe 10 may include a heating element (or panel) 12, a lining 14, a layer of memory foam 16, a temperature sensor 18, a control 20 for controlling heated shoe 10, a printed circuit board (PCB) 22, and one or more connectors 26. Heel 11 may be comprised of a charging circuit 24 and one or more battery(ies) 13 disposed within heel 11. In an exemplary embodiment, one or more connectors 26 may electrically connect one or more battery(ies) 13 to PCB 22. A charging unit 19 may be used to charge (or recharge) one or more battery(ies) 13 via charging circuitry 24, which may be an induction charging circuit or another wireless charging system. In some examples, charging unit 19 may be a pad, a base, or any other device suitable for induction charging one or more battery(ies) 13. Heated shoe 10, including heating element 12 and heel 11, and charging unit 19, may collectively form an exemplary system.

Heating element 12 may be textile-based and may be encapsulated using a polymer material, or other suitable material. Heating element 12 may be made by using ink or cutting the textile into a specific geometry and pressing the entire unit together with heat using temperature sensitive conductive adhesives, or other suitable processes. Heating element 12 may be made from a flat and/or lightweight textile. Heating element 12 may extend to cover a portion of or all of heated shoe 10. FIG. 1 depicts heating element 12 as extending across a length of heated shoe 10.

Heating element 12 may be an e-textile. This e-textile of heated shoe 10 may include electronics integrated directly into the textile substrates. This may include either passive electronics, such as conductors and resistors, or active components, such as transistors, diodes and solar cells. E-textile of heated shoe 10 may also include hybrids in which electronic components embedded in the textile are connected to known electronic devices and/or components. In an exemplary embodiment, the fabric used in manufacturing the e-textile may be a smart textile fabric. Smart textile fabrics may be made from materials ranging from traditional cotton, polyester, and nylon, to advanced Kevlar with integrated functionalities. However, in the scope of the present disclosure, fabrics with electrical conductivity are of interest. Several examples of heating element 12 woven into a fabric are found throughout the disclosure.

Memory foam 16 may be comprised of a layer of formed polyurethane or other suitable material. Memory foam 16 may include additional chemicals during manufacturing to increase its viscosity and density. In some examples, a higher-density memory foam may be used in heated shoe 10. A higher-density memory foam may soften a reaction to body heat, allowing the foam to better mold to a contour of a warm body, e.g., a wearer's foot, in a few minutes. When heat dissipates, the memory foam returns to its original shape. Memory foam 16 may be seated on heating element 12 so as to also absorb heat via thermal conduction so as to soften the memory foam 12 further to conform to a wearer's foot. Heating element 12 may also be placed on top of memory foam 16 in some cases.

Lining 14 may also function as an insole. Lining 14 may be comprised of a layer of material that sits inside the shoe that creates a layer between the sole and the wearer's foot. Lining 14 may add comfort for the wearer, while hiding memory foam 15 and heating element 12.

As further depicted by FIG. 1, PCB 22 may be disposed over a heel portion of heated shoe 10. PCB 22 may be flexible and may be manufactured to include a flexible substrate. PCB 22 may be located below a rear-portion of heating element 12. PCB 22 may be electrically connected to heating element 12 so as to provide electrical power, and adequate conductivity, to heating element 12 to generate heat. PCB 22 may be a custom printed circuit board, which may include circuitry customized based on the amount of heat desired to be generated by heated shoe 10 and/or the specifications of the shoe, e.g., heel size, type, shape, etc. Circuitry of PCB 22 may provide control over heating element 12 and/or other elements of heated shoe 10.

Connectors 26 may be disposed within or on a face of PCB 22 at one end, and connected to battery(ies) 13 of heated shoe 10. Connectors 26 may be electrically connected to PCB 22 and/or battery 13 with electrical wiring, or any suitable electrical connection. Connectors 26 may be used to form an electrical connection to provide power from battery(ies) 13 to heating element 12. Connectors 26 may be flat and/or slim in design so as to create a smaller footprint when connecting to the electrical wiring of heating element 12. Connectors 26 may also be flexible. Heated shoe 10 is designed to be light and/or flat in design requiring less material, and lowering manufacturing costs. In some embodiments, connectors 26 may be pins. In some examples, connectors 26 may form an electrical connection, or a mechanical connection with PCB 22 and/or battery(ies) 13. In an exemplary embodiment, the connectors 26 may be magnetic, mini-coaxial, LEK, YOKOW connectors (pogo PIN/waterproof), or Deans connectors, or other suitable mechanical/electrical connectors.

In an exemplary embodiment, charging circuitry 24 may be disposed within a heel of a shoe, or other footwear, and below battery(ies) 13, as shown in FIG. 1. Charging circuitry 24 may be operable to charge, and re-charge, battery(ies) 13 of heated shoe 10. Inductive charging (also known as wireless charging) uses an electromagnetic field to transfer energy between two objects through electromagnetic induction. This is generally completed with a charging station or base, such as, charging unit 19. Charging circuitry 24 may be an induction charging receiver. Charging circuitry 24 may automatically turn on (e.g., activate) charging/recharging battery 13 once heel 11 is placed in a slot of a charging base (such as charging unit 19). In some examples, charging circuitry 24 may also be configured to receive a charge from any coil induction device. Charging circuitry 24 may be configured for receiving a charge by induction in any suitable way.

In the exemplary embodiment, charging circuitry 24 may be charged by induction chargers and an induction coil to create an alternating electromagnetic field from within charging unit 19. A second induction coil in the portable device may take power from the electromagnetic field and convert it back into electric current to charge battery(ies) 13. In some examples, battery(ies) 13 may be rechargeable. It can be appreciated that charging circuitry 24 may use resonant inductive coupling, or other suitable inductive charging methods.

In an exemplary embodiment, charging unit 19 may be a charging base and may include induction charging transmitters, an auto turn-off circuit, a voltage regulator circuit, a charger base housing, and/or a wall plug. Induction charging transmitters may be disposed under each charging area of the charging base. Transmitters may be embedded inside the charging base at specified locations where heel 11 may sit during charging. The auto turn-off circuit may be disposed within the charging base. The auto turn-off circuit may turn off the charging module once battery 13 is completely charged. The voltage regulator circuit may be disposed with the charging base. The voltage regulator circuit may regulate voltage from a wall outlet to one or more of the induction charging transmitters. The charging base housing may be comprised of a robust material. The charging base, in some embodiments, may be sized to accommodate two shoes (or one pair of shoes) to seat comfortably on a surface of the charging base. The wall plug may include a housing comprised of a resilient material. Wall plug may also be sized to accommodate two shoes (or one pair of shoes).

In other embodiments, charging unit 19 may be a charging station, such as a pad, or a mat, and may be in wireless contact with the heel of the shoe so as to charge the battery of the shoe. In some embodiments, energy may be sent through an inductive coupling to an electrical device, which may then use the energy to charge batteries and/or operate the device. Battery 13 may be rechargeable using induction charging circuitry 24. In one example, battery 13 may be a rechargeable NiMH battery that is chargeable (and rechargeable). Battery 13 may be one or more batteries, as depicted in FIG. 1. Heel 11 of heated shoe 10 may include a hollow heel portion to house and/or insulate battery 13 from an external environment, e.g., outside air. In some examples, a battery pack injection mold holder may be used in heated shoe 10, and disposed within heel 11 of the shoe. A battery connection circuit, including a type and number of batteries, may be disposed within the battery pack holder. Battery 13, in some embodiments, may last for over 5 hours on auto-mode without needing to be recharged. In some embodiments, PCB connectors 26 are connected to battery 13 via the battery pack holder. In these examples, the connection may be robust and reliable. Adhesives and/or nails may be used between the shoe sole and heel 11 to assist in strengthening this connection.

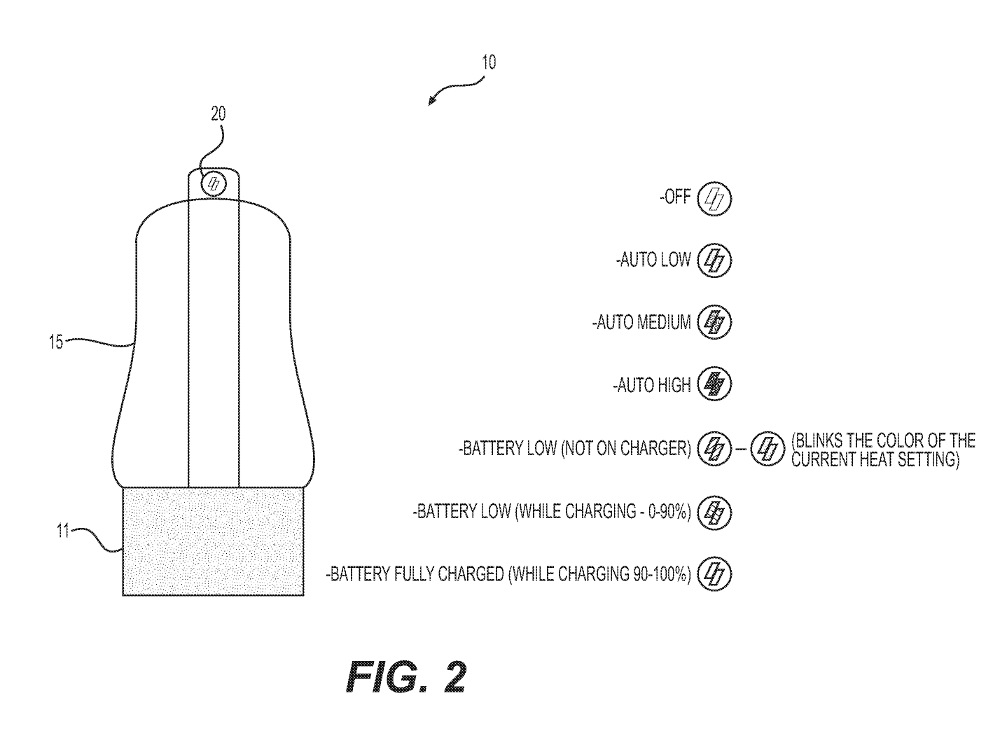

With reference now to FIG. 2 of the drawings, heated shoe 10 may include a control 20. While control 20 is shown located at the rear of heated shoe 10, control 20 may be located in any other suitable portion of heated shoe 10, such as on a side of heated shoe 10. For example, control 20 may wirelessly interface with elements of heated shoe 10 (e.g., PCB 22). For example, control 20 may be provided on a remote device, including, for example, a remote control or a software application on a device such as a smart phone. Electrical connections between control 20 and other portions of heated shoe 10 (e.g., PCB 22) need not be wired connections.

In some examples, control 20 may be comprised of a button, a switch, an on/off device, a zipper, or other suitable device. Control 20 may also be configured to operate as a user interface (UI) of heated shoe 10. In some examples, control 20 may comprise a control button, which may include a control interface and/or a user interface. Control 20 may be used for a thermal regulation feature of heated shoe 10 to control the temperature of heating element 12 via a manual control switch. Control 20 may also be used as an “on/off” switch to turn heated shoe 10 on or off. Lastly, control 20 may be used a battery level indicator. Control 20 may also include an LED indicator with the “on/off” switch, e.g., a membrane switch with embedded LED. The LED indicator may include various symbols representative of which mode heated shoe 10 is being operated in and/or a power level indicator of battery 13. The LED indicator may notify a wearer of any of the following states (e.g., operating states) of heated shoe 10: “Off”, “Auto Low”, “Auto Medium”, “Auto High”, or “Battery Low.” “Battery Low” may communicate when battery 13 is not on the charging base, when battery 13 is charging, or when battery 13 is fully charged. Indicator LED may turn red when battery 13 is below 20% charged, yellow when charged between 20% and 90%, and green when 90% or more charged. In some examples, the LED indicator may always remain on while heated shoe 10 is in an “on” state. For example, the LED indicator may blink when battery 13 is below 20%. In some examples, when battery 13 is charging, the LED indicator may blink, either occasionally, intermittently or constantly, and may eventually turn to a solid green light once battery 13 is completely charged.

When control 20 is used for the temperature regulation feature of heated shoe 10, the UI of heated shoe 10 may permit the wearer to switch heated shoe 10 from an automatic control mode to a manual control mode, or vice versa, using the manual control switch. In some embodiments, the manual control switch may include an LED indicator. When activating the manual control switch, the wearer may control the temperature setting of heated shoe 10 (i.e., a temperature of the shoe internally as a function of powering up or powering down heating element 12). Temperature sensor 18, as depicted in FIG. 1, may be used to sense the internal temperature of heated shoe 10. In some examples, heated shoe 10 and/or UI may continuously request temperature data from sensor 18 in order to track the temperature.

When heated shoe 10 is in the manual control mode, the wearer may navigate between three (3) temperature settings. In an exemplary embodiment, the three (3) settings may include auto-low, auto-medium, or auto-high. When heated shoe 10 is manually controlled, temperature sensor 18 automatically maintains the internal shoe temperature at a setting selected by the wearer. For example, the wearer may select the highest temperature setting when the wearer is in a cold environment, e.g., outdoors during the winter. In some embodiments, the three (3) temperature settings are pre-set, e.g., factory settings.

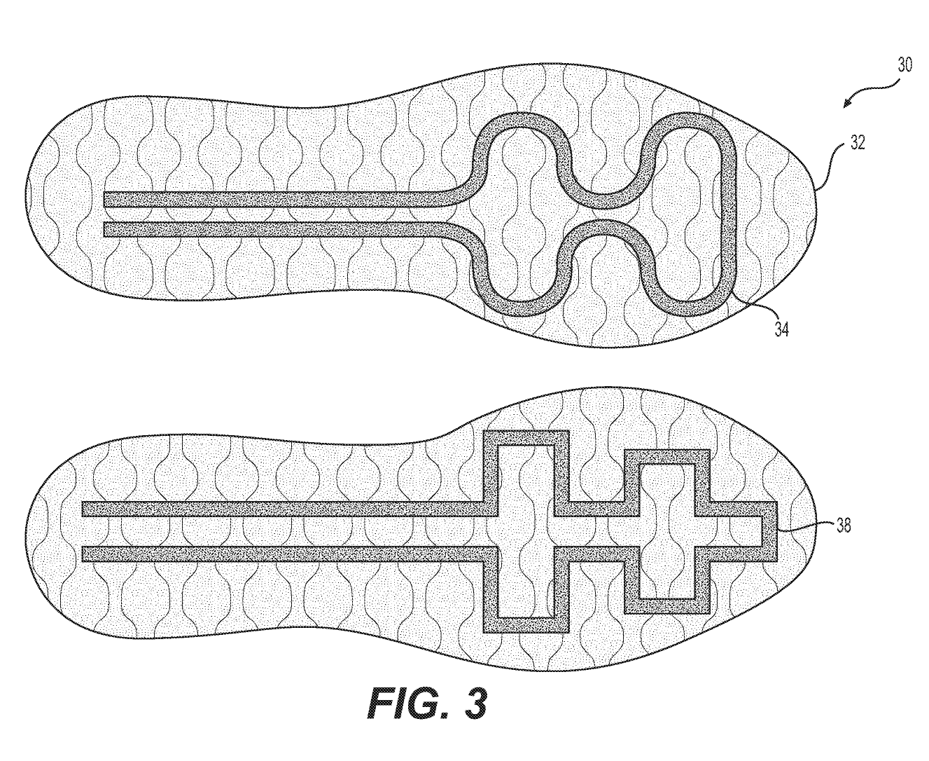

With reference now to FIG. 3, shown is an exemplary embodiment of a heating panel 32, including a heating element 34 delineating an exemplary geometry of heating element 34. Heating panel 32 may also include heating element 38, which may be another exemplary geometry of a heating element according to aspects of this disclosure. Heating element 34 or 38 and heating panel 32 collectively form an exemplary embodiment of heating element 12 (not shown) of heated shoe 10 (not shown). When operating heated shoe 10, low-powered heating of heated shoe 10 may be possible by modulating the design of heating element 34 or 38 with thin and/or thick portions. A manufacturing process may permit heating to cover large surface areas by heating sections from one panel (e.g., heating panel 32). In some examples, thick sections of heating panel 32 may not heat, whereas thin sections may heat. As a consequence of this thin-to-thick heating element design, controlled heating may be possible.

In some examples, heating element 34 or 38 may be a temperature sensor circuit (e.g., a wire made of copper or other suitable thermo-conductive material). In an exemplary embodiment, heating element 34 or 38 is a wire embedded within the fabric of heating panel 32, according to aspects of the disclosure previously recited. The temperature sensor circuit of heating element 34 or 38 may be configured to respond with accurate readings of the shoe environment of heated shoe 10. For example, when the temperature falls below a certain predetermined level, the temperature sensor circuit may activate heating panel 32. Temperature sensor 18, in some embodiments, may be operably connected to heating panel 32 via PCB 22.

In one embodiment, heating panel 32 may ideally function on 3.6 V and 0.1 amps to produce 5 hours of functionality from 6 2.5 amp batteries. Heating panel 32, however, should not reach a temperature level greater than 110 degrees Fahrenheit to perform optimally, and should support a low temperature threshold down to 77 degrees Fahrenheit.

As alluded to earlier, heating pad 32 and heating element 34 or 38 may collectively be manufactured by cutting the textile into a specific geometry and pressing the entire unit together with heat. In doing so, the heating element is made into an insole within the shoe.

These and other embodiments of the systems and methods may be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Those of ordinary skill in the art will recognize that the systems, apparatuses, devices, and methods described herein can be applied to, or easily modified for use with, other types of applications.

It is intended that the specification and examples be considered as exemplary only, with a true scope and spirit of the invention being indicated by the following claims.

What is claimed is:

1. A heated article comprising:
a circuit board;
one or more batteries electrically connected to the circuit board;
a flexible heating element electrically connected to the circuit board;
a control switch electrically connected to the circuit board and configured to selectively adjust the heating element; and
circuitry configured to charge the one or more batteries.

2. The heated article of claim 1, wherein the heated article comprises a heated shoe.

3. The heated article of claim 3, wherein the heated article includes a heel portion, and wherein the one or more batteries are disposed within the heel portion.

4. The heated article of claim 3, wherein the heated article includes a heel portion, and wherein the circuit board is disposed above the heel portion.

5. The heated article of claim 1, wherein the flexible heating element includes a textile.

6. The heated article of claim 1, further comprising a temperature sensor.

7. The heated article of claim 6, wherein the circuit board includes circuitry configured to adjust the heating element in response to a reading from the temperature sensor.

8. The heated article of claim 1, wherein the control switch comprises an LED indicator.

9. The heated article of claim 1, wherein the circuitry is configured to wirelessly charge the one or more batteries.

10. The heated article of claim 9, wherein the one or more batteries are wirelessly charged by inductive charging.

11. A heated article comprising:
a flexible heating element;
a rechargeable battery, wherein the rechargeable battery is configured to provide power to the flexible heating element;
circuitry for connecting the rechargeable battery to the flexible heating element; and
a temperature sensor connected to the circuitry.

12. The heated article of claim 11, wherein the heated article comprises a heated shoe.

13. The heated article of claim 12, wherein the heated article includes a heel portion, and wherein the battery is disposed within the heel portion.

14. The heated article of claim 11, wherein the circuitry is configured to adjust the heating element in response to a reading from the temperature sensor.

15. The heated article of claim 11, wherein the one or more rechargeable batteries are wirelessly charged by inductive charging.

16. A heated article, comprising:
a flexible heating element comprising a textile;
a rechargeable battery, wherein the rechargeable battery is configured to provide power to the flexible heating element;
circuitry for connecting the rechargeable battery to the flexible heating element; and
an LED indicator.

17. The heated article of claim 16, wherein the LED indicator is configured to display a power level of the rechargeable battery.

18. The heated article of claim 16, wherein the LED indicator is configured to display an operating state of the heated article.

19. The heated article of claim 16, further comprising a temperature sensor.

20. The heated article of claim 16, wherein the heated article comprises a shoe.
